(19) United States
(12) Patent Application Publication
(10) Pub. No.: US 2004/0213118 A1
(43) Pub. Date: Oct. 28, 2004

(54) Method of reading audio data, and optical disk player

(76) Inventor: Rik Swusten, Zaventem (BE)

Correspondence Address: BIRCH STEWART KOLASCH & BIRCH, PO BOX 747, FALLS CHURCH, VA, 22040-0747, US

(21) Appl. No.: 10/828,290

(22) Filed: Apr. 21, 2004

(30) Foreign Application Priority Data
Apr. 22, 2003 (JP) 2003-116591

(51) Int. Cl. G11B 7/005

(52) U.S. Cl. 369/53.35; 369/124.08

(57) ABSTRACT

The method is capable of securely reading audio data from an optical disk with reducing errors. The method comprises the steps of: reading the audio data, which are divided into a plurality of data units, from the optical disk; detecting an error flag of each of the data units so as to check if a reading error exists in each of the data units or not; rereading the audio data from the optical disk and storing the audio data of the data units, in which no reading errors exist, if the reading error exists in at least one of the data units; repeating the rereading-and-storing step prescribed times; and combining the stored audio data of the data units, in which no reading errors exist, so as to reproduce the recorded audio data.

### BACKGROUND OF THE INVENTION

The present invention relates to a method of reading audio data recorded in an optical disk and an optical disk player capable of reading data from an optical disk.

If a large scratch or a broad stain exists in an optical disk, e.g., CD, DVD, some data recorded in the optical disk cannot be correctly read. To correctly read data from the optical disk, error correcting codes are added to the data. By adding the error correcting codes, data incorrectly read can be corrected.

In optical disks, CIRCs (Cross Interleaved Reed-Solomon Code) are used as the error correcting codes. In one CIRC, a couple of Reed-Solomon codes are interleave-connected. A couple of the Reed-Solomon codes is constituted by a C1 code and a C2 code. The C1 code mainly corrects random errors; the C2 code mainly corrects burst errors. The C1 and the C2 codes are added to each data of one byte.

In some cases, even if data include the C1 and the C2 codes, the data cannot be reproduced. If the data cannot be reproduced, a C2 flag of each byte of the data, which cannot be corrected, is turned on.

Data are read block by block. Each block is constituted by 2352 bytes of data. When the C2 flag is detected in at least one of bytes of the one block, a conventional optical disk player judges that a reading error occurs and rereads the data of the one block from the beginning.

As described above, the C2 flag is turned on when the read error cannot be corrected. In this case, the conventional disk player abandons previous data and rereads the same data with slower reading velocity. This rereading action is called retry.

However, in some cases, the former error part of the data, in which the reading error has occurred, can be correctly read but another reading error occurs in another part of the data. If the reading error occurs in another part, the correct data of the one block cannot be completely read. Namely, the conventional optical disk player cannot securely read data.

Unlike ordinary data, if a reading error of audio data cannot be corrected by retry, the block of the audio data including the error part may be supplemented with data of the foregoing block and the following block. Namely, severe correction is not required to audio data in comparison with ordinary data. Function of correcting error of an audio player may be comparatively low.

However, if the block including the error part is supplemented with the adjacent blocks, the reproduced audio data are different from the original audio data, so that a listener has a feeling of disorder. Namely, the conventional optical disk player cannot correctly read audio data.

### SUMMARY OF THE INVENTION

An object of the present invention is to provide a method of securely reading audio data from an optical disk with reducing errors.

Another object is to provide an optical disk player capable of performing said method.

To achieve the objects, the present invention has following structures.

Namely, the method of the present invention comprises the steps of:

reading the audio data, which are divided into a plurality of data units, from the optical disk;

detecting an error flag of each of the data units so as to check if a reading error exists in each of the data units or not;

rereading the audio data from the optical disk and storing the audio data of the data units, in which no reading errors exist, if the reading error exists in at least one of the data units;

repeating the rereading-and-storing step prescribed times; and

combining the stored audio data of the data units, in which no reading errors exist, so as to reproduce the recorded audio data.

On the other hand, the optical disk player of the present invention comprises:

means for reading audio data, which are divided into a plurality of data units, from the optical disk;

means for detecting an error flag of each of the data units;

means for storing the audio data of the data units;

means for controlling the reading means, the detecting means and the storing means,

wherein the controlling means reads the audio data from the optical disk; detects the error flag of each of the data units so as to check if a reading error exists in each of the data units or not; rereads the audio data from the optical disk and stores the audio data of the data units, in which no reading errors exist, if the reading error exists in at least one of the data units; repeats the rereading-and-storing step prescribed times; and combines the stored audio data of the data units, in which no reading errors exist, so as to reproduce the recorded audio data.

With the method and the optical disk player, the audio data of the blocks, in which no reading errors exist, can be combined, so that the original audio data can be reproduced without reading errors.

In the method and the optical disk player, the controlling means may combine the stored audio data of the data units, in which no reading errors exist, and the read audio data of the data unit, in which a reading errors exists, so as to reproduce the recorded audio data if the reading error still exists in at least one of the data units after the rereading-and-storing step are repeated the prescribed times. With this structure, if reading errors cannot be removed by rereading the audio data the prescribed times, number of reading errors can be reduced. Therefore, audio data, which are very similar to the original audio data, can be reproduced.

In the method and the optical disk player, a size of each of the data units may be one byte. With this structure, the data units are very small, the combined audio data are very similar to the original audio data

In the method and the optical disk player, data reading velocity may be changed when the whole reproduced audio data are reread. With this structure, occurring reading errors can be restrained, so that the audio data can be securely read.

### BRIEF DESCRIPTION OF THE DRAWINGS

Embodiments of the present invention will now be described by way of examples and with reference to the accompanying drawings, in which:

FIG. 1 is an explanation view of a structure of audio data and a C2 flag;

FIGS. 2A-2D are explanation views showing steps of an embodiment of the method of the present invention;

FIGS. 3A-3D are explanation views showing steps of another embodiment of the method of the present invention;

FIG. 4 is a block diagram of an embodiment of the optical disk player of the present invention;

FIG. 5 is a flowchart of reading audio data by the optical disk player shown in FIG. 4;

FIG. 6 is a block diagram of another embodiment of the optical disk player of the present invention, wherein audio data are read by an external computer;

FIG. 7 is a block diagram of the external computer for reading audio data; and

FIG. 8 is a flowchart of reading audio data by the external computer shown in FIG. 7.

### DETAILED DESCRIPTION OF THE EMBODIMENTS

Preferred embodiments of the present invention will now be described in detail with reference to the accompanying drawings.

In the embodiments of the present invention, audio data are read from an optical disk, e.g., CD, CD-R, CD-RW, DVD. The read audio data of each one byte are checked if a reading error exits therein or not. The correct audio data including no reading error are stored byte by byte. The recorded audio data are reread a prescribed times. The stored correct audio data, which have been stored byte by byte, are combined to reproduce the recorded audio data.

### (Reading Recorded Audio Data)

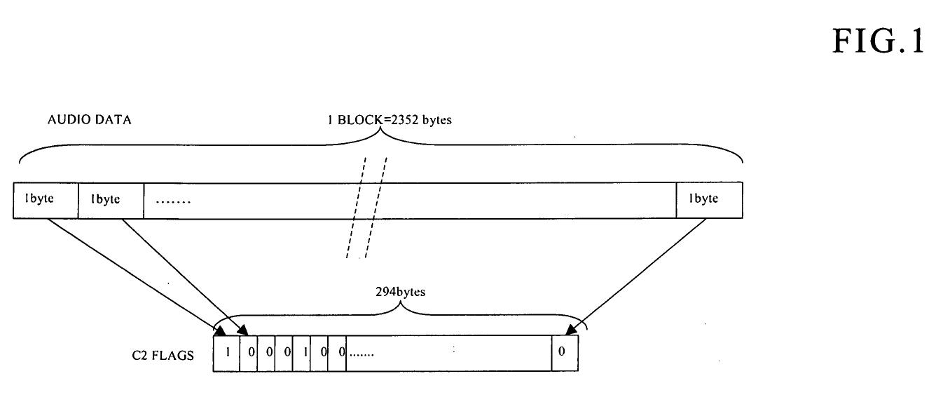

Firstly, a structure of the audio data will be explained with reference to FIG. 1.

Audio data are read from an optical disk block by block. Each block is constituted by audio data of 2352 bytes.

As described in BACKGROUND OF THE INVENTION, reading errors in the audio data, which have been read from the optical disk, are corrected by CIRC. If the reading errors cannot be corrected by CIRC, the C2 flags indicating reading errors in each byte are turned on (“1”). Namely if reading errors exist after one block of the audio data are corrected by CIRC, the C2 flags are turned on. The C2 flags are data of 294 bytes with respect to the audio data of one block.

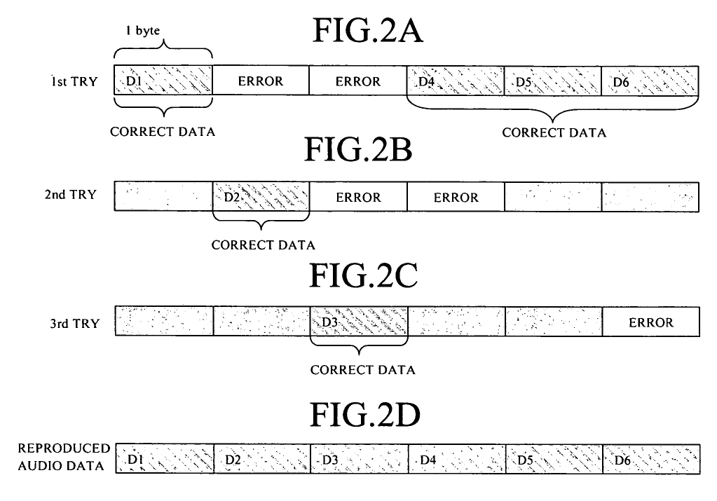

A method of reading audio data from the optical disk will be explained with reference to FIGS. 2A-2D. An actual size of one block is 2352 bytes, but the size of one block is 6 bytes in the following explanation so as to easily understand. And, maximum number of rereading audio data from the optical disk (retry) is three times.

In FIG. 2A, the audio data are firstly read (first try), then reading errors exist in a second byte and a third byte. The errors can be known if the C2 flags are on or off. The C2 flags indicate the bytes whose reading errors were not corrected.

If reading errors exist in any bytes, the audio data of bytes including no reading errors, i.e., a first byte, a fourth byte, a fifth byte and a sixth byte, are stored in storing means, e.g., a semiconductor memory, as correct data D1, D4, D5 and D6 (see FIG. 2D). Then, the audio data are reread.

In FIG. 2B, the audio data are reread (second try), then reading errors exist in the third byte and the fourth byte. Correct data are included in the first byte, the second byte, the fifth byte and the sixth byte. At that time, the correct data D1, D4, D5 and D6 have been already stored in the storing means, so required data are D2 and D3.

Therefore, the audio data of the second byte are stored in the storing means as the correct data D2 (see FIG. 2D). Then, the audio data are reread again.

In FIG. 2C, the audio data are reread (third try), then reading errors exist in the sixth byte. Correct data are included in the first byte to the fifth byte. At that time, the correct data D1, D2, D4, D5 and D6 have been already stored in the storing means, so required data are D3.

Therefore, the audio data of the third byte, which could not correctly read at the first try and the second try, are stored in the storing means as the correct data D3 (see FIG. 2D).

When the third try is finished, all of the correct date D1-D6 are stored in the storing means as complete reproduced audio data (see FIG. 2D). A user can play back with the complete reproduced audio data.

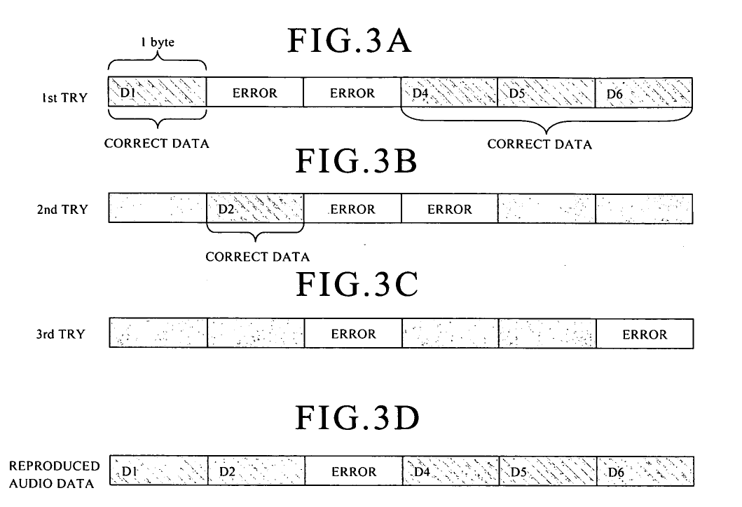

In the present example, all of the correct data can be stored by rereading three times. In some cases, all of the correct data cannot be got by rereading three times. For example, in the third try, if reading errors exist in the third byte and the sixth bite (see FIGS. 3A-3D), the correct data D1, D2, D4 and D5 can be stored in the storing means.

Namely, the correct data of the third byte (D3) could not be got. In this case, the audio data are reproduced with the stored correct data D1, D2, D4 and D5. With this method, the audio data can be reproduced with minimizing reading errors.

Note that, the above described method may be executed in the optical disk player, in which the optical disk storing the original audio data is set, or a computer connected with the optical disk player.

### (First Embodiment)

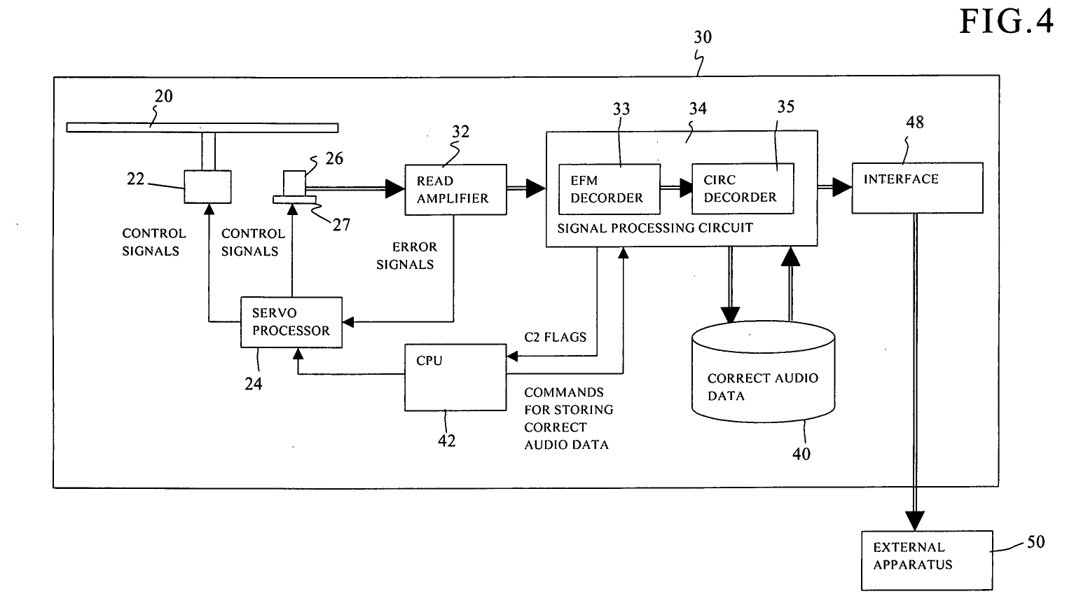

In a first embodiment, the above described method is executed in an optical disk player. Firstly, the optical disk player will be explained with reference to FIG. 4. In FIG. 4, thick arrows indicate flows of data; thin arrows indicate flows of control signals.

In the present embodiment, the optical disk player 30 is connected to an external apparatus 50 via an interface 48. Audio data read from an optical disk 20 are transferred to the external apparatus 50.

The optical disk 20 is rotated by a spindle motor 22. A servo processor 24 sends control signals to the spindle motor 22 to rotate the optical disk 20.

The audio data recorded in the optical disk 20 are read by an optical pick-up 26, which includes a laser diode for emitting laser beams, a photo detector for receiving the laser beams reflected from the optical disk 20, etc.

The optical pick-up 26 is moved in a radial direction of the optical disk 20 by a moving mechanism 27. The moving mechanism 27 includes a guide shaft, which supports and guides the optical pick-up 26 to move in said direction, and a servo motor (not shown), which moves the optical pick-up 26 on the guide shaft.

The servo processor 24 sends control signals to control the moving mechanism 27.

A read amplifier 32 is connected to the optical pick-up 26. The read amplifier 32 amplifies high frequency components of the audio data read from the optical disk 20 and converts them into binary digital data. The read amplifier 32 extracts tracking error signals, focusing error signals, etc. from the audio data, which have been read from the optical disk 20, and sends them to the servo processor 24.

The servo processor 24 sends tracking control signals, focusing control signals, etc. to the optical pick-up 26 on the basis of the error signals so as to control the optical pick-up 26.

A signal processing circuit 34, which includes a decoder 33 for EFM demodulation and another decoder 35 for CIRC demodulation, is connected to the read amplifier.

The EFM decoder 33 EFM-demodulates the data sent from the read amplifier 32; the CIRC decoder 35 correct the read audio data on the basis of C1 codes and C2 codes when the read audio data includes a reading error. If the CIRC decoder 35 cannot correct the reading error, a C2 flag corresponding to the one byte including the reading error is turned on. A CPU 42 checks each byte if the C2 flag is turned on or not.

If completely correct audio data, which include no reading errors, are got, the reproduced audio data are sent to the external apparatus 50 via the interface 48.

A storing means 40, e.g., a semiconductor memory, a hard disk, is connected to the signal processing circuit 34. The correct audio data of each byte, whose C2 flag is not turned on, are stored in the storing means 40.

The CPU 42 controls the whole system of the optical disk player 30. The CPU 42 works on the basis of control programs previously stored in a memory, e.g., ROM.

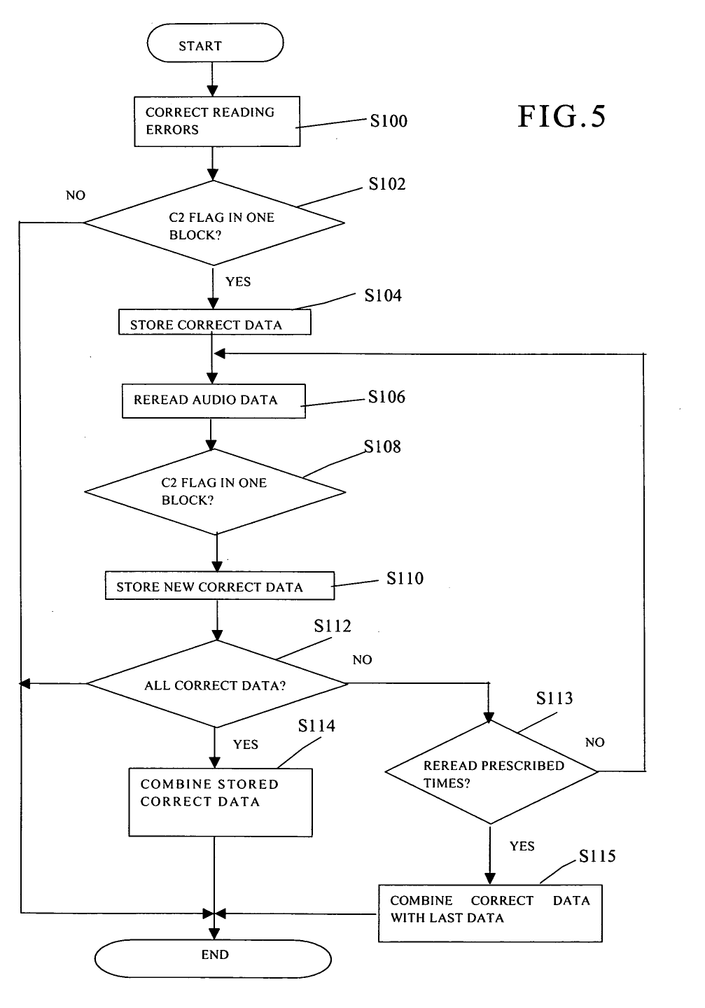

The action of the CPU 42 will be explained with reference to a flow chart of FIG. 5. Note that, number of rereading or retry is previously defined by the control programs of the CPU 42.

Firstly, the CPU 42 reads the audio data from the optical disk 20 by the optical pick-up 26, then controls the signal processing circuit 34 to correct reading errors (step S100).

When correcting data of one block is completed, the CPU 42 checks if the C2 flags exist in the one block or not, namely checks if there are any reading errors, which cannot be corrected, still exist in the one block or not (step S102).

If all of the read data of the one block are correct data or no C2 flags are in the one block, the CPU 42 outputs the read audio data of the one block via the interface 48 as correct audio data. Therefore, reading audio data of the one block is completed.

Note that, the correct audio data of the one block may be stored in a buffer memory (not shown), and the correct audio data of a plurality of blocks may be simultaneously outputted.

On the other hand, if the CPU 42 detects at least one C2 flag in the one block in the step S102, the CPU 42 stores the correct data of each byte, whose C2 flag is not turned on, in the storing means 40 (step S104).

Then, the CPU 42 controls the servo processor 24, etc. to reread the audio data of the same block (step S106). This action is called retry.

Note that, data reading velocity of the retry may be slower than that of the former reading action so as to securely read the audio data.

The CPU 42 checks if the C2 flags exist in the same one block, which are read by retry, or not (step S108). If all of the read data of the one block are correct data, the CPU 42 outputs the read audio data of the one block via the interface 48 as correct audio data. Therefore, reading audio data of the one block is completed.

If the CPU 42 detects at least one C2 flag in the same one block, which has been read by retry, the CPU 42 compares the present correct data of each byte, whose C2 flag is not turned on, with the stored correct data of each byte. Then, the CPU stores the present correct data of each byte, other than the stored correct data, in the storing means 40 (step S110). Namely, new correct data are stored.

In the next step S112, the CPU 42 checks if all of the correct data of the one block are got or not. If all of the correct data are got, the CPU 42 combines the correct data stored in the storing means 40 as reproduced audio data of the one block (step S114). Then, the CPU 42 controls the signal processing circuit 34 so as to output the reproduced audio data via the interface 48. Therefore, reading audio data of the one block is completed.

On the other hand, if all of the correct data of the one block are not got in the step S112, the CPU 42 checks if retry has been executed prescribed times of not (step S113). If the retry has not been executed prescribe times, the CPU returns to the step S106 to reread the audio data of the same one block.

If all of the correct data are not got in spite of rereading the audio data prescribed times, the CPU 42 goes to a step S115 and combines the stored correct data with the last read data, which include reading errors, so that the audio data of the one block can be reproduced. With this method, number of reading errors in the reproduced audio data can be minimized.

Namely, the CPU 42 supplements the stored correct data, which have been stored in the storing means 40, with the last data, which have been read in the final retry, so as to reproduce the audio data. The supplemented data include reading errors but the number of reading errors in the reproduced audio data can be minimized by rereading the data. After the audio data are reproduced, the CPU 42 controls the signal processing circuit 34 so as to output the reproduced audio data via the interface 48. Therefore, reading audio data of the one block is completed.

### (Second Embodiment)

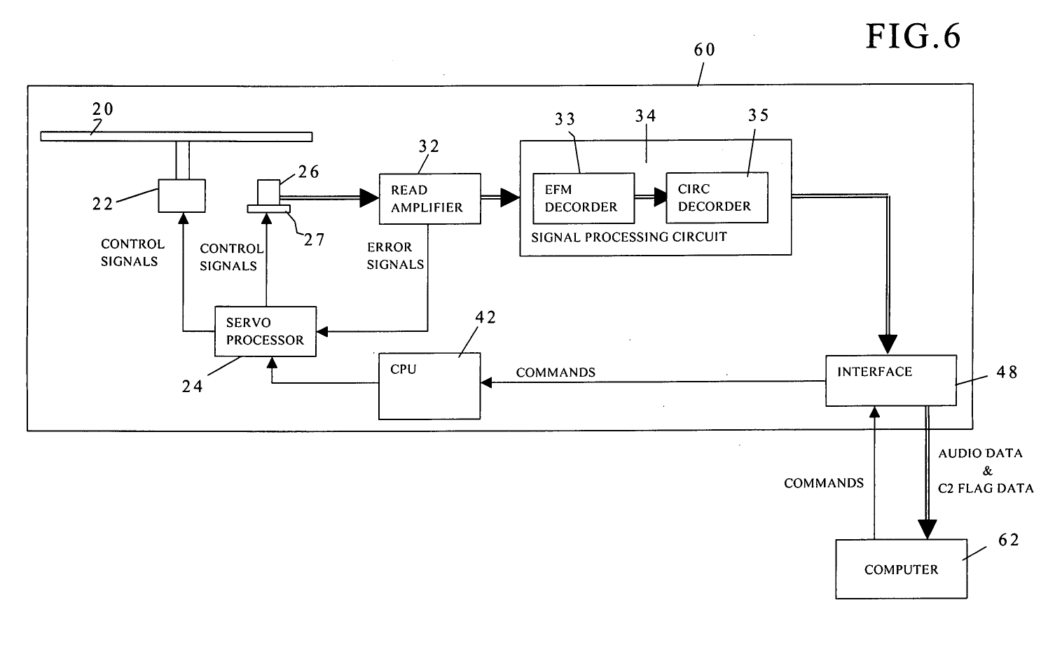

In a second embodiment, the above described method is executed in a computer connected to an optical disk player. The second embodiment explained with reference to FIGS. 6-8. Note that, the structural elements explained in the first embodiment are assigned the same symbols and explanation will be omitted.

In the case of storing audio data, which have been sent from an optical disk player, in an external compute, a file for audio data, e.g., WAVE file, is made in the computer.

An optical disk player 60 is capable of reading audio data from the optical disk 20 set therein. The optical disk player 60 is controlled on the basis of command signals sent from a computer 62.

Unlike the optical disk player 30 of the first embodiment, the optical disk player 60 of the present embodiment has no storing means 40, in which the correct data are stored. Namely, the optical disk player 60 is an ordinary optical disk player.

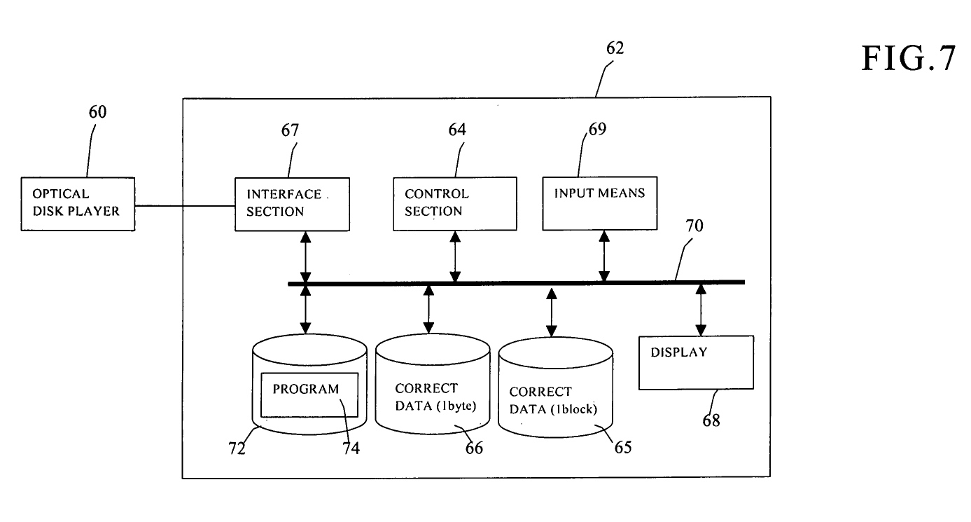

As shown in FIG. 7, the computer 62 is an ordinary personal computer including: a control section 64 constituted by a CPU, etc.; a plurality of storing means 65, 66 and 72, e.g., RAM, hard disk; an interface section 67 for connecting the optical disk 60; display means 68; and an input means 69, e.g., keyboard, pointing device. The elements of the computer 62 are mutually connected via a bus 70.

A program 74, which controls the optical disk player 60 and other elements of the computer 62 so as to read audio data, is stored in the storing means 72.

When a user inputs a command for starting the program 74 via the input means 69, the control section 74 executes the program 74, so that the above described method of reading audio data can be executed.

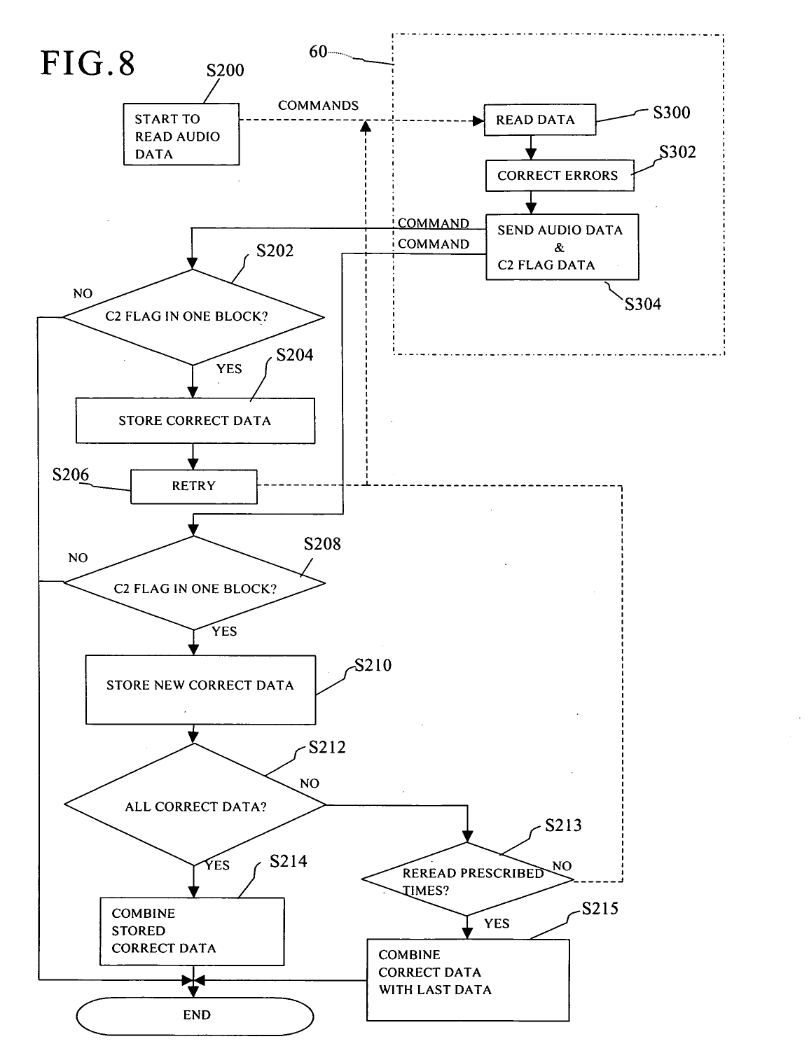

The action of the computer 62, which is based on the program 74, will be explained with reference to a flow chart of FIG. 8. Note that, number of rereading or retry is previously determined by the user.

Firstly, the program 74 starts, so that an operation window is shown by the display means 68. The use can input a command for reading audio data via the input means 69.

When the user inputs the command for reading audio data, the control section 64 sends a command for reading audio data to the optical disk player 60 via the interface section 67 (step S200).

The CPU 42 of the optical disk player 60 receives the command from the computer 62 and controls the servo processor 24, etc. to read audio data from the optical disk 20 (step S300).

Reading errors included in the read audio data are corrected by the decoders 33 and 35 of the signal processing circuit 34 (step S302). When the audio data of one block are decoded, the CIRC decoder 35 generates C2 flag data, which indicate C2 flags in the audio data of the one block. Then, the CPU 42 sends the audio data and the C2 flag data to the computer 62 via the interface 48 (step S304).

When the computer 62 receives the audio data and the C2 flag data, the control section 64 checks if the C2 flags exist in the one block or not, namely checks if there are any reading errors, which cannot be corrected, still exist in the one block or not (step S202).

If all of the read data of the one block are correct data or no C2 flags are in the one block, the control section 64 stores the read audio data of the one block in the storing means 65 as correct audio data. Therefore, reading audio data of the one block is completed.

On the other hand, if the control section 64 detects at least one C2 flag in the one block in the step S202, the control section 64 stores the correct data of each byte, whose C2 flag is not turned on, in the storing means 66 (step S204).

Then, the control section 64 sends to a retry command to the optical disk player 60 so as to reread the audio data of the same block (step S206).

Note that, data reading velocity of the retry may be slower than that of the former reading action so as to securely read the audio data. The user may optionally select the data reading velocity of the retry.

The reread audio data are sent from the optical disk player 60 to the computer 62, and the control section 64 repeats the steps S300-304. The control section 64 checks if the C2 flags exist in the same one block, which are read by retry, or not. If all of the read data of the one block are correct data, reading audio data of the one block is completed. Then, the control section 64 sends a command for reading audio data of the next block.

If the control section 64 detects at least one C2 flag in the same one block, which has been read by retry, the control section 64 compares the present correct data of each byte, whose C2 flag is not turned on, with the correct data of each byte stored in the storing means 66. Then, the CPU stores the present correct data of each byte, other than the stored correct data, in the storing means 66 (step S210). Namely, new correct data are stored.

In the next step S212, the control section 64 checks if all of the correct data of the one block are stored in the storing means 66 or not. If all of the correct data are stored, the control section 64 combines the correct data stored in the storing means 66 as reproduced audio data of the one block (step S214). Then, the control section 64 stores the reproduced audio data in the storing means 65. Therefore, reading audio data of the one block is completed.

On the other hand, if all of the correct data of the one block are not got in the step S212, the control section 64 checks if retry has been executed prescribed times of not (step S213).

If the retry has not been executed prescribe times, the control section 64 sends the retry command to the optical disk player 60 again so as to make the optical disk player 60 reread the audio data of the same one block.

On the other hand, if all of the correct data are not got in spite of rereading the audio data prescribed times, the control section 64 goes to a step S215 and combines the stored correct data with the last read data, which include reading errors, so that the audio data of the one block can be reproduced. With this method, number of reading errors in the reproduced audio data can be minimized.

Namely, the control section 64 supplements the stored correct data, which have been stored in the storing means 66, with the last data, which have been read in the final retry, so as to reproduce the audio data. The supplemented data include reading errors but the number of reading errors in the reproduced audio data can be minimized by rereading the data. After the audio data are reproduced, the control section 64 stores the reproduced audio data in the storing means 65. Therefore, reading audio data of the one block is completed.

Note that, the program 74 is not limited a program stored in the storing means 72. For example, other storing means, to which the control section 64 can directly access, e.g., FD, CD, MO, may be used for storing the program 74.

In the second embodiment, three storing means 65, 66 and 72 are provided in the computer 62 but a memory area of one storing means may be divided into three sub-areas, which can respectively work as the storing means 65, 66 and 72.

In the first and the second embodiments, a size of each of the data units is one byte, but the size is not limited to one byte.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A method of reading audio data from an optical disk,
comprising the steps of:
reading the audio data, which are divided into a plurality of data units, from the optical disk;
detecting an error flag of each of the data units so as to check if a reading error exists in each of the data units or not;
rereading the audio data from the optical disk and storing the audio data of the data units, in which no reading errors exist, if the reading error exists in at least one of the data units;
repeating said rereading-and-storing step prescribed times; and
combining the stored audio data of the data units, in which no reading errors exist, so as to reproduce the recorded audio data.

2. The method according to claim 1,
wherein the stored audio data of the data units, in which no reading errors exist, and the read audio data of the data unit, in which a reading errors exists, are combined so as to reproduce the recorded audio data if the reading error still exists in at least one of the data units after said rereading-and-storing step are repeated the prescribed times.

3. The method according to claim 1,
wherein a size of each of the data units is one byte.

4. The method according to claim 1,
wherein data reading velocity is changed when the audio data are reread.

5. An optical disk player capable of reading audio data from an optical disk set therein,
comprising:
means for reading audio data, which are divided into a plurality of data units, from the optical disk;
means for detecting an error flag of each of the data units;
means for storing the audio data of the data units;
means for controlling said reading means, said detecting means and said storing means,
wherein said controlling means reads the audio data from the optical disk; detects the error flag of each of the data units so as to check if a reading error exists in each of the data units or not; rereads the audio data from the optical disk and stores the audio data of the data units, in which no reading errors exist, if the reading error exists in at least one of the data units; repeats the rereading-and-storing step prescribed times; and combines the stored audio data of the data units, in which no reading errors exist, so as to reproduce the recorded audio data.

6. The optical disk player according to claim 5,
wherein said controlling means combines the stored audio data of the data units, in which no reading errors exist, and the read audio data of the data unit, in which a reading errors exists, so as to reproduce the recorded audio data if the reading error still exists in at least one of the data units after the rereading-and-storing step are repeated the prescribed times.

7. The optical disk player according to claim 5,
wherein a size of each of the data units is one byte.

8. The optical disk player according to claim 5,
wherein data reading velocity is changed when the audio data are reread.
